(19) United States
(12) Patent Application Publication
(10) Pub. No.: US 2002/0150668 A1
(43) Pub. Date: Oct. 17, 2002

(54) Method and apparatus for continuously treating fat-containing masses to be processed

(76) Inventor: Gerhard Ridderbusch, Bad Salzuflen (DE)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/116,933

(22) Filed: Apr. 5, 2002

(30) Foreign Application Priority Data
Apr. 12, 2001 (DE) 10118354.2-41

(51) Int. Cl. A23D 7/00

(52) U.S. Cl. 426/601

(57) ABSTRACT

A method of continuously treating a chocolate mass to be processed includes the steps of suspending thermally treated seed crystals in a partial mass of the chocolate mass to form a suspension and adding the suspension to the chocolate mass. An apparatus for continuously treating a chocolate mass to be processed includes a tank being designed and arranged to store the chocolate mass, a conveying conduit being designed and arranged to connect the tank with a consumer and to convey the chocolate mass towards the consumer, a conveying pump being arranged in the conveying conduit, a conduit including an exit and being designed and arranged to introduce a suspension including seed crystals into the conveying conduit, a dose pump being arranged in the conduit, and a tempering machine being connected to the conveying conduit and including at least one cooling stage and at least one mixing stage, the mixing stage having a beginning portion, the beginning portion being connected to the exit of the conduit in a way to introduce the suspension including seed crystals into the chocolate mass.

### CROSS REFERENCE TO RELATED APPLICATIONS

This application claims the benefit of co-pending German Patent Application No. 101 18 354.2-41 entitled “Verfahren und Vorrichtung zum kontinuierlichen Aufbereiten von zu verarbeitenden fetthaltigen Massen”, filed on Apr. 12, 2001.

### FIELD OF THE INVENTION

The present invention generally relates to a method and an apparatus for continuously treating fat-containing masses to be processed. More particularly, the present invention relates to seed crystallization of chocolate masses in the food industry.

Generally, seed crystallization is not primarily directed to the aspect of pre-crystallization by special temperatures prevailing in a tempering machine including the steps of cooling and reheating the mass. Seed crystallization is directed to introducing seed crystals into a conveying conduit in which the chocolate mass flows. In this way, pre-crystallization of the chocolate mass is realized by introducing seed crystals. Although the present application uses the term “chocolate mass”, the present invention and the novel method and the novel apparatus may also be used for treating similar masses containing cocoa butter or different fat-containing masses. With respect to chocolate masses, it is desired to attain pre-crystallization in a way that the finished product (after crystallization) has all the desired properties, as there are shine, cracking breakage, no fat frost and the like.

### BACKGROUND OF THE INVENTION

A method and an apparatus for continuously treating fat-containing masses to be processed is known from PCT Application Number PCT/EP99/03734 with the International Publication Number WO 00/72695 A1. The PCT application describes a method of producing seed crystal suspensions based on melted fat having an increased share of β_{VI} crystal modification, and their use during seed crystallization of fat-based suspensions that contain disperse solid particles such as chocolates and chocolate-like masses or the like. It is desired to adjust the overall share of crystals, the share of high melting β_{VI} crystal modifications as well as the average crystal size in the seed crystal suspension. For this purpose, a cold-sprayed fat powder is subjected to thermal conditional steps in a way that a change of modification of the polymorph fat system continues until the share of thermally highly stable β_{VI} crystals is more than or equal to 10%. The fatty powder conditioned in this way is suspended in the melt of fat including no crystals and being tempered at a temperature of below approximately 1 to 2° C. below the melt enthalpy peak minimal temperature of the β_{VI} crystal modification. In the case of treating a chocolate mass, cocoa butter is used as fat melt. The fat powder suspension is treated by shearing/extensional flow treatment while taking mechanical and thermal conditions as well as the time of treatment into account. The treatment takes place until the desired properties, as there are overall crystal share, β_{VI} modification share and average crystal size, have been reached. The seed crystal suspension is produced in a rather complicated way. The seed crystal suspension is uniformly added to the entire product stream of chocolate or of a similar mass to be pre-crystallized and having a share of seed crystals between 0.01 and 0.2% (with respect to the entire mass). Then, the suspension is mixed in the product stream in a gentle, homogeneous and continuous way. The apparatus for conducting the method requires use of a cold spring tower, a tempering chamber, a suspension mixing container, a shearing/extension flow module, a pump and a static mixer. Additionally, a tank for supplying the heated liquid chocolate mass and a conveying conduit leading to the consumer and including a conveying pump are necessary. A heat exchanger and a static mixer being located downstream thereof are located in the conveying conduit. The known construction requires substantial structural expenditure and a complicated method of producing and conditioning the seed crystals. It is necessary to use cocoa butter in addition to the chocolate mass.

### SUMMARY OF THE INVENTION

The present invention relates to a novel method of continuously treating a chocolate mass to be processed. The novel method includes the steps of suspending thermally treated seed crystals in a partial mass of the chocolate mass to form a suspension and adding the suspension to the chocolate mass.

The present invention also relates to a novel apparatus for continuously treating a chocolate mass to be processed. The novel apparatus includes a tank being designed and arranged to store the chocolate mass, a conveying conduit being designed and arranged to connect the tank with a consumer and to convey the chocolate mass towards the consumer, a conveying pump being arranged in the conveying conduit, a conduit including an exit and being designed and arranged to introduce a suspension including seed crystals into the conveying conduit, a dose pump being arranged in the conduit, and a tempering machine being connected to the conveying conduit and including at least one cooling stage and at least one mixing stage, the mixing stage having a beginning portion, the beginning portion being connected to the exit of the conduit in a way to introduce the suspension including seed crystals into the chocolate mass.

The novel method and apparatus do not require great structural expenditure, and they are easy to use. With the novel method and apparatus, the production of seed crystals and the treatment of the chocolate mass are conducted in two separate steps. The production of seed crystals may be realized by special production factories, or at least in a centralized way for a plurality of consumers (machines using the mass) within a factory processing chocolate mass. In this way, the structural expenditure for each consumer is substantially reduced. The remaining treatment process of the chocolate mass taking place at each single consumer is simplified in a way that it may be realized with a structural mechanical expenditure corresponding to the expenditure without using seed crystals. In this way, the treatment of the chocolate mass is simplified, and the likelihood of defects is reduced. The novel method and apparatus fulfill the conditions and possibilities in practical operation in a special way. It is even possible to use usual tempering machines or already existing tempering machines in the novel method. In such a case, it is only necessary to control the tempering machine in a slightly different way than before. The use of conventional tempering machines also allows for using them for seed crystal pre-crystallization as well as for conventional tempering. Consequently, already existing systems may be easily retrofitted to conduct the novel method.

The seed crystals are suspended in a partial mass of the chocolate mass, meaning not in the entire mass. Consequently, it is not necessary to supply and handle a separate fat melt, especially cocoa butter. However, it is still possible to use such a fat melt, for example cocoa butter. It is preferred to use seed crystals produced by special producers, or at least being produced at one place of the factory processing chocolate masses in a way that the production conditions of the seed crystals in the form of powder may be realized in a better and more simple way even when producing great amounts of crystals. In this way, the individual consumer—for example the individual coating machine—does not have to fulfill this function. It is only necessary to introduce the suspension already including the seed crystals into the conveying conduit for the chocolate mass, and to mix it with the chocolate mass in a gentle, homogeneous and continuous way. Preferably, the mixing process takes place in the mixing stage of a conventional tempering machine by using the pre-heat stage as the mixing stage without requiring additional expenditure.

The novel method does not desire to realize a seed crystal suspension having a high β_{VI} modification share, but rather to attain such pre-crystallization within the chocolate mass in a way that the known requirements of a product made of chocolate mass may be fulfilled. Fatty frost and effects like the surface of the chocolate turning gray are prevented. The finished chocolate product has a shining surface and crackling breakage properties. The novel method realizes the production of crystals which easily melt in the mouth, as it is desired by the consumer. The novel method is directed to pre-crystallization in a way that the finished product substantially includes β_{V} crystals. This form of crystals allows for good shaping properties, good shine and long stability in storage.

The novel method may be also conducted in a way that the seed crystals are produced by shearing/extensional flow treatment of cocoa butter. The cocoa butter crystal suspension is then suspended in the partial mass of the chocolate mass. When realizing the suspension in this way, problems concerning storage, dosage and handling of crystal powders are prevented. The already existing cocoa butter may be directly used to produce the seed crystals by using a shearing crystallization unit. Usually, the cocoa butter will be fed through the shearing crystallization unit several times until the necessary amount of crystals has been produced. Due to feeding the mass back into a reservoir tank, and the mass remaining in the reservoir tank for a certain period of time, there is sufficient time for the mass to produce the desired stable crystal modification. Additionally, the desired share of cocoa butter crystallization suspension may be realized. The cocoa butter crystallization also forms some sort of a pre-suspension which in term is added to the partial mass of the chocolate mass, and it is suspended therein. In this way, the process of uniformly distributing the seed crystals is simplified.

Preferably, the suspension includes a share of seed crystals of more than 0.2% (with respect to the entire chocolate mass). This means that the novel method uses more seed crystals in the suspension than it is known from the prior art. However, the actual share of seed crystals still is rather small when considering the share in the entire mass consisting of the suspension and the chocolate mass. Due to the insertion of the seed crystals only into a portion of the chocolate mass, the seed crystals already tend to multiply in this partial mass. It is desired to distribute the inserted seed crystals and the newly built seed crystals in the suspension in a fine and uniform way. A variety of different mixing units may be used for this purpose, the mixing units being located in the conduit with which the suspension is fed to the conveying conduit for the chocolate mass.

It is especially advantageous if the suspension is added to a partial mass of the chocolate mass which already includes seed crystals. This means that the entrance of the conduit into which the seed crystals are added and in which they are suspended is connected to the part of the conveying conduit leading to the consumer. In this way, a circuit is realized through which the chocolate mass may be guided for a plurality of times in a way that an increase of the share of seed crystals and exact adjustment of the share of seed crystals is possible.

With the novel method, there is the advantage of making it possible to use conventional tempering machines, and—at the same time—to cool the chocolate mass before adding the suspension containing seed crystals only down to a temperature of approximately 31° C. to 35° C., especially to approximately 32° C. to 34.5° C. Consequently, it is no longer necessary to cool the entire chocolate mass down to approximately 28° C. to 29° C., as it is required in the prior art.

The process of homogeneously mixing the suspension including seed crystals with the chocolate mass may be conducted without substantially changing the temperature. Consequently, the conventional water circuit for the pre-heating stage of a tempering machine is not necessarily required. However, it may still be used, for example, in a throttled way. Special cooling steps within the conduit for the suspension are not required.

The present invention also relates to a novel apparatus for continuously treating a chocolate mass to be processed which includes a first conduit being designed and arranged to convey the chocolate mass, a second conduit including an exit and being designed and arranged to introduce a suspension including seed crystals into the first conduit, and a tempering machine being connected to the first conduit and including at least one cooling stage and at least one mixing stage, the mixing stage having a beginning portion, the beginning portion being connected to the exit of the second conduit in a way to introduce the suspension including seed crystals into the chocolate mass.

The novel apparatus does not use an individual separate heat exchanger, but instead a conventional tempering machine including one or more cooling stages and a pre-heating stage. Such tempering machines are well known. The last cooling stage facing the pre-heating stage may be designed as crystallization stage. The water circuits of this tempering machine may have a simplified design, and they may be controlled in a simplified way. Using the conventional tempering machine only requires slightly different control. The prior cooling stage or the prior cooling stages still function as one or more cooling stages, the cooling process being less intensive and ending at temperatures of approximately 32° C. to 33° C. The water circuit for the pre-heating stage is not required at all, it may be operated in a throttled way, or it may be locked such that the former pre-heating stage now fulfills the function of a mixing stage. The already existing stirring tools in the tempering machine operate as mixing elements to mix the suspension including seed crystals with the chocolate mass being guided through the cooling stage in a gentle, homogeneous and uniform way. For this purpose, the conduit for continuously introducing the suspension including seed crystals into the conveying conduit for the chocolate mass and including the dose pump in the region of its exit or of its end is connected to the beginning of the pre-heating stage of the conventional tempering machine now having a different function. The connection may also be realized at the end of the cooling stage, or at the transition between the cooling stage and the mixing stage. Using a conventional tempering machine being controlled in a different way means that the mechanical expenditure is strongly reduced. Providing the conduit and dosing the suspension also is not complicated since the processes of producing the seed crystals, on the one hand, and treating the chocolate mass, on the other hand, are two separate steps. Using a conventional tempering machine for conducting the novel methods also allows for switching between a first mode “seed crystal crystallization” and a second mode “conventional tempering” and vice versa. Consequently, already existing systems may be easily changed for the novel application of introducing seed crystals. They may be handled as easy as conventional systems since the main stream of chocolate mass remains unchanged. The novel apparatus may be easily used at each consumer in a non-central way.

The conduit for continuously introducing the suspension into the conveying conduit for the chocolate mass may be part of a circuitry in which an increase of the seed crystals takes place during circulation. This preferred embodiment of the novel apparatus allows for an exact adjustment of the share of seed crystals in the conduit, and for its dosage with respect to the chocolate mass. It is to be understood that the conduit for continuously introducing the suspension into the conveying conduit for the chocolate mass with its entrance side is connected to the part of the conveying conduit which leads from the tempering machine to the consumer. Even when it is not desired that the mass circulates through the circuit for a plurality of times, the above-described connection of the entrance of the conduit to the part of the conveying conduit leading from the tempering machine to the consumer may also be used.

Another possibility of designing the novel apparatus is such that the entrance of the conduit for continuously introducing the suspension into the conveying conduit for the chocolate mass is connected to the end of the cooling stage of the tempering machine. The chocolate mass at the end of the cooling stage has a temperature of approximately 31° C. to 35° C., especially of approximately 32° C. to 34° C. Such a temperature is suitable to add the seed crystals into this conduit without harming the seed crystals, and making it possible to increase the number of crystals in the conduit.

Another possibility of designing the conduit is to connect the entrance of the conduit for continuously introducing the suspension into the conveying conduit for the chocolate mass to the tank for the liquid heated chocolate mass. The mechanical structural expenditure for this embodiment is slightly more than for the above-described embodiments. Since the melted chocolate mass being located in the tank has a temperature of approximately 45° C., it is necessary to arrange a separate heat exchanging unit in the conduit, the heat exchanging unit cooling the part of the chocolate mass serving to form the suspension down to a temperature of approximately 31° C. to 35° C., especially to approximately 32° C. to 35° C.

Other features and advantages of the present invention will become apparent to one with skill in the art upon examination of the following drawings and the detailed description. It is intended that all such additional features and advantages be included herein within the scope of the present invention, as defined by the claims.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. In the drawings, like reference numerals designate corresponding parts throughout the several views.

FIG. 1 is a connection diagram of a first exemplary embodiment of the novel apparatus for continuously treating chocolate mass to be processed.

FIG. 2 is a connection diagram of a second exemplary embodiment of the novel apparatus.

FIG. 3 is a connection diagram of a third exemplary embodiment of the novel apparatus.

FIG. 4 is a connection diagram of another exemplary embodiment of the novel apparatus.

### DETAILED DESCRIPTION

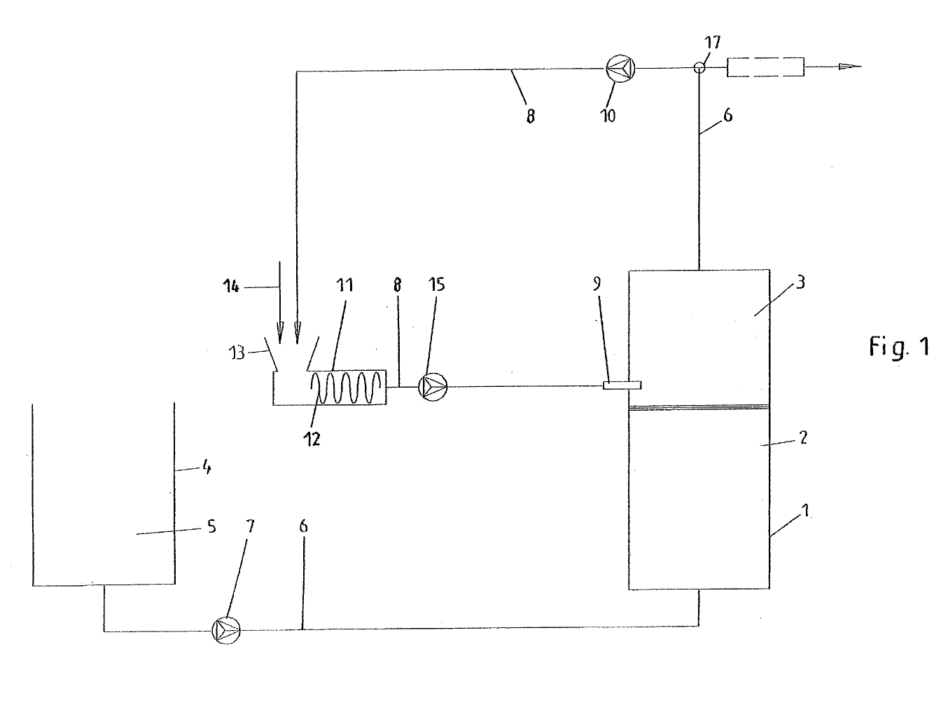

Referring now in greater detail to the drawings, FIG. 1 schematically illustrates a tempering machine 1. The tempering machine 1 may be designed as a so called disc tempering machine. The tempering machine 1 includes a cooling stage 2 and a mixing stage 3. The tempering machine 1 may also include a plurality of cooling stages 2 being located one above the other. This means that the tempering machine 1 may include a plurality of cooling circuits to be separately controlled. Such structural elements of tempering machines are well known in the art, and they are therefore not illustrated in greater detail. The mixing stage 3 may be designed as a pre-heating stage as it is known in the art, but in a way to have a different function.

Usually, such a disc tempering machine includes a plurality of different levels. It includes mass chambers through which the chocolate mass streams, and cooling chambers and heating chambers, respectively, through which a tempering medium of the respective tempering circuit flows. Furthermore, the tempering machine 1 includes mixing tools (not illustrated) to be rotatably driven. The mixing tools in the cooling stage 2 serve to mix the chocolate mass and to control the temperature. In the mixing stage 3, the mixing tools or the stirring tools fulfill a mixing function since there is no substantial change of temperature of the chocolate mass. As in usual systems, there is a tank 4 to hold and to supply liquid chocolate mass 5. The melted chocolate mass 5 being located in the tank 4 has a temperature of approximately 45° C.

A conduit 6 leads from the tank 4 to a consumer (not illustrated)—for example a coating machine, a hard candy pouring machine and the like—via the tempering machine 1. A conveying pump 7 is located in the part of the conduit 6 which leads from the tank 4 to the tempering machine 1. A conduit 8 branches off at the part of the conduit 6 which starts from the tempering machine 1 and which leads to the consumer. The conduit 8 includes a one way seed valve 9, and it is connected to the mixing stage 3 of the tempering machine 1. In this way, the conduit 8 together with parts of the conveying conduit 6 forms a circuitry through which chocolate mass may also pass for a plurality of times. A first dose pump 10 is located in the conduit 8. An open mixing device 11 including driven mixing tools 12 is located in the flowing direction as indicated by arrows. The mixing device 11 includes a hopper or a funnel 13 in a way that seed crystals as powder may be added to a part of the chocolate mass at this place according to arrow 14. A second dose pump 15 is arranged downstream of the open mixing device 11. The suspension of chocolate mass and seed crystals is conveyed by the second dose pump 15 via the one way seed valve 9 to reach the mixing stage 3.

With the novel system, it is possible to conduct the novel method for continuously treating chocolate mass to be processed. The chocolate mass at the consumer has a temperature of approximately 31° C. or 32° C. to 35° C. The melted chocolate mass 5 contained in the tank 4 is conveyed through a tempering machine 1 by the conveying pump 7. The chocolate mass 5 is cooled in the cooling stage 2 to reach a temperature of approximately 31° C. to 35° C., especially to approximately 32° C. to 35° C. Having this temperature, the chocolate mass 5 enters the mixing stage 3 in which the temperature does not substantially change. The temperature of the chocolate mass 5 in the cooling stage 2 may also be further decreased to take the amount of heat being applied by the mixing tools in the mixing stage 3 into account. In this way, the desired processing temperature at the consumer is reached.

A switching valve 17 may be located in the part of the conveying conduit 6 which leads from the tempering machine 1 to the consumer. The switching valve 17 makes it possible to have an influence on the distribution of the chocolate mass reaching the consumer and of the chocolate mass being located in the conduit 8, respectively. In this way—especially when starting the system—part of the chocolate mass may be introduced into the circuit of the conduit 8 until the desired amount or concentration of seed crystals or inoculation crystals has been reached, as it is desired for the beginning of manufacture at the consumer. However, the switching valve 17 is not necessarily required. It is also possible to use a simple T-piece. The dose pump 10 conveys a portion of the chocolate mass into the conduit 8. According to arrow 14, the necessary amount of seed crystals as powder is introduced at the funnel 13 of the open mixing device 11. Consequently, the crystals are distributed in the chocolate mass by the mixing tools 11. Due to this mixing process, additional seed crystals will form in the chocolate mass. The attained chocolate mass is added to the remaining stream of chocolate mass in the mixing stage 3 via the one way seed valve 9 and by the dose pump 15. The suspension including seed crystals is intermixed with the chocolate mass coming from the cooling stage 2 in the mixing stage 3 in a gentle, homogeneous and continuous way such that pre-crystallized chocolate mass exits from a tempering machine 1 to reach the consumer via the conveying conduit 6. It is clear that the dose pump 10 sucks in chocolate mass which already includes inoculation crystals, meaning it is partly pre-crystallized. The amount of seed crystals increases during its circulation through the circuit. Usually, this increase is not sufficient to realize the desired crystallization level of the chocolate mass in the mixing stage 3. For this reason, seed crystals are continuously added according to arrow 14.

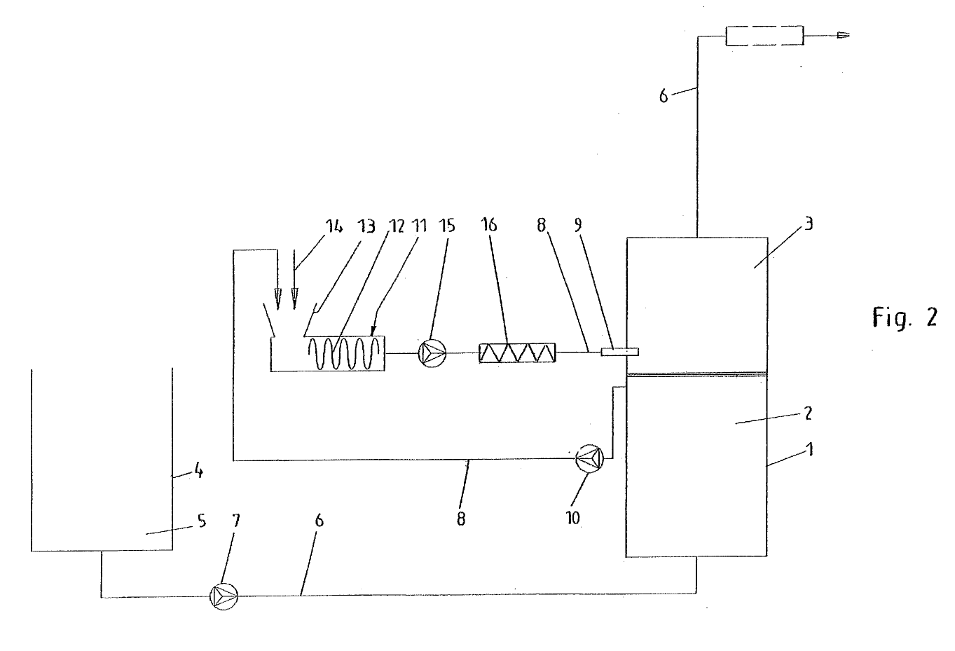

The second exemplary embodiment of the novel system as illustrated in FIG. 2 has a similar design with respect to the arrangement of the tempering machine 1 and of the tank 4, as well as of the conveying conduit 6 leading to the consumer. Consequently, it is referred to the above explanation. In addition to the exemplary embodiment of FIG. 1, the system according to FIG. 2 includes a static mixing unit 16 being located downstream of the second dose pump 15. The static mixing unit 16 does not include driven elements or rotating elements. The static mixing unit 16 serves to further uniformly distribute the seed crystals in the suspension before it reaches the mixing stage 3. Furthermore, the conduit 8 with its entrance is located at a different position. It is connected to the end of the cooling stage 2 of the tempering machine 1. For this reason, there is no circuit, but it is rather possible to send part of the chocolate mass being located at the end of the cooling stage 2 in the tempering machine 1 through the conduit 8, to add seed crystals according to arrow 14, and to introduce the mass into the chocolate mass at the beginning of the mixing stage 3.

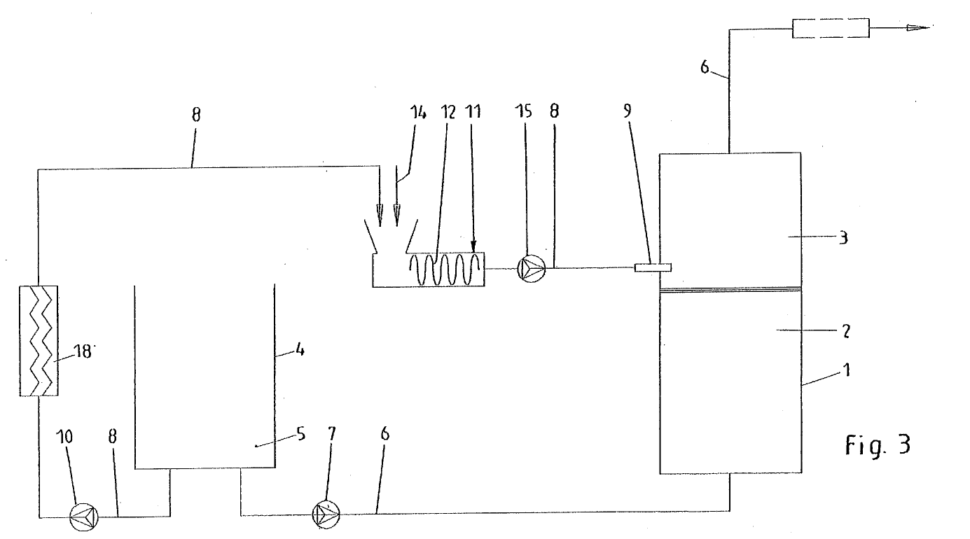

FIG. 3 illustrates another exemplary embodiment of the novel apparatus. With respect to identical or similar elements, it is referred to the above description. The entrance of the conduit 8 has a different connection. It is directly connected to the tank 4 containing the liquid chocolate mass 5. A heat exchanger 18 is located in the conduit 8. Part of the chocolate mass is conveyed to the heat exchanger 18 by the dose pump 10. The chocolate mass 5 flowing through the conduit 8 is cooled down to reach approximately 31° C. to 35° C., especially approximately 32° C. to 35° C., by the heat exchanger 18 before the seed crystals are introduced in the form of powder according to arrow 14. Again, the exit of the conduit 8 ends at the beginning of the mixing stage 3 of the tempering machine 1.

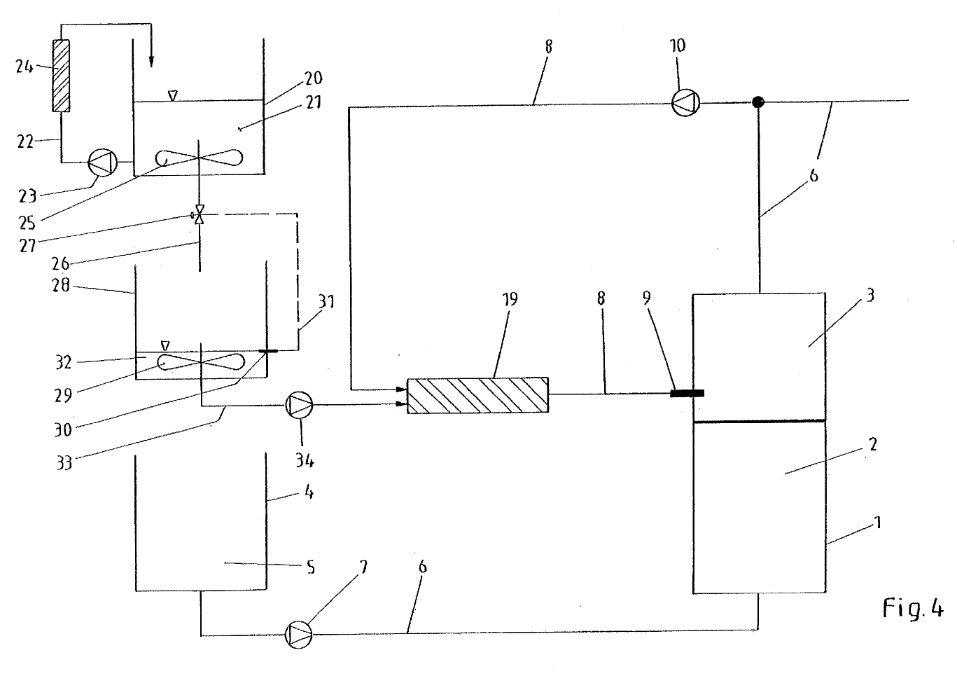

FIG. 4 illustrates another exemplary embodiment of the novel system. With respect to its use, its structure and the arrangement of the tempering machine 1, it is referred to the above descriptions of the other exemplary embodiments of the novel system. The dose pump 10 takes part of the chocolate mass from the conveying conduit 6, and it conveys this partial mass in the direction of a mixing unit 19. In the illustrated exemplary embodiment, the mixing unit 19 is designed as a static conduit mixing unit not including movable or driven elements. However, the mixing unit may also have a different design. The conduit 8 leads from the mixing unit 19 to the one way seed valve 9 being located at the tempering machine 1.

The exemplary embodiment of the novel system as illustrated in FIG. 4 includes a reservoir tank 20 in which cocoa butter 21 is located. A conduit 22 including a pump 23 is connected to the reservoir tank 20 to form a circuit. A shearing crystallization unit 24 is located in the conduit 22. The shearing crystallization unit 24 has a design known in the art. The cocoa butter 21 is subjected to shearing/extensional flow treatment. The shearing crystallization unit 24 operates in a mechanical/thermal way such that crystals are formed in the cocoa butter 21. The crystals are suspended in the cocoa butter 21. The suspension and the cocoa butter 21, respectively, is revolved in a continuous way and for a plurality of times, respectively, in a way that it again and again reenters the reservoir tank 20. In this way, one realizes the necessary period of time of treatment to allow for the desired stable crystals. A mixing apparatus 25 serves to thoroughly mix the cocoa butter 21. A certain amount of cocoa butter 21 including the desired stable crystals is produced and contained in the reservoir tank 20. A conduit 26 leads from the reservoir tank 20 to a stirring tool tank 28 also including a stirring tool 29. A valve 27 is located in the conduit 26. The stirring tool tank 28 includes a level switch 30 which controls the valve 27 by an electric line 31. When the level is less than what has been predetermined by the level switch 30, the valve 27 is opened in a way that a certain amount of the suspension 32 including cocoa butter crystals is located in the mixing tool tank 28, and it may be refilled into the mixing tool tank 28, respectively. A conduit 33 including a pump 34 leads from the mixing tool tank 28 to a second entrance of the static mixing unit 19. The partial amount of chocolate of the conduit 9 and the respectively dosed amount of the suspension 32 including cocoa butter and seed crystals are brought into contact to be thoroughly intermixed in the mixing unit 19 and by the mixing unit 19, respectively. In this way, the pre-suspension of cocoa butter and seed crystals forms the suspension of seed crystals to be suspended in the partial amount of the chocolate mass. The resulting suspension of the pre-suspension and of the partial chocolate mass is then introduced into the chocolate mass by the one way seed valve 9 to form the entire chocolate mass.

Many variations and modifications may be made to the preferred embodiments of the invention without departing substantially from the spirit and principles of the invention. All such modifications and variations are intended to be included herein within the scope of the present invention, as defined by the following claims.

I claim:

1. A method of continuously treating a chocolate mass to be processed, comprising the steps of:
suspending thermally treated seed crystals in a partial mass of the chocolate mass to form a suspension; and
adding the suspension to the chocolate mass.

2. The method of claim 1, wherein the chocolate mass has been cooled before the step of adding the suspension to the chocolate mass, and wherein in the step of suspending thermally treated seed crystals in a partial mass of the chocolate mass to form a suspension the mass is intermixed in a gentle, homogeneous and continuous way.

3. The method of claim 1, wherein the suspension includes more than approximately 0.2 percent of seed crystals with respect to the entire chocolate mass.

4. The method of claim 2, wherein the suspension includes more than approximately 0.2 percent of seed crystals with respect to the entire chocolate mass.

5. The method of claim 1, wherein the chocolate mass to which the suspension is added already includes seed crystals.

6. The method of claim 2, wherein the chocolate mass to which the suspension is added already includes seed crystals.

7. The method of claim 3, wherein the chocolate mass to which the suspension is added already includes seed crystals.

8. The method of claim 4, wherein the chocolate mass to which the suspension is added already includes seed crystals.

9. The method of claim 1, wherein the chocolate mass before having added the suspension has a temperature of approximately 31° C. to approximately 35° C.

10. The method of claim 2, wherein the chocolate mass before having added the suspension has a temperature of approximately 31° C. to approximately 35° C.

11. The method of claim 1, wherein the suspension and the chocolate mass are homogeneously intermixed without substantial changes of temperature.

12. The method of claim 1, wherein the chocolate mass has a processing temperature of approximately 31° C. to approximately 35° C.

13. A method of continuously treating a chocolate mass to be processed, comprising the steps of:
producing seed crystals by shearing/extensional flow treatment of cocoa butter to form a first suspension;
suspending the first suspension in a partial mass of the chocolate mass to form a second suspension; and
adding the second suspension to the chocolate mass.

14. The method of claim 13, wherein the chocolate mass has been cooled before the step of adding the second suspension to the chocolate mass, and wherein in the step of suspending the first suspension in a partial mass of the chocolate mass to form a second suspension the mass is intermixed in a gentle, homogeneous and continuous way.

15. The method of claim 13, wherein the suspension includes more than approximately 0.2 percent of seed crystals with respect to the entire chocolate mass.

16. The method of claim 14, wherein the suspension includes more than approximately 0.2 percent of seed crystals with respect to the entire chocolate mass.

17. The method of claim 13, wherein the chocolate mass to which the suspension is added already includes seed crystals.

18. The method of claim 13, wherein the chocolate mass before having added the suspension has a temperature of approximately 31° C. to approximately 35° C.

19. The method of claim 14, wherein the chocolate mass before having added the suspension has a temperature of approximately 31° C. to approximately 35° C.

20. An apparatus for continuously treating a chocolate mass to be processed, comprising:
a tank being designed and arranged to store the chocolate mass;
a conveying conduit being designed and arranged to connect said tank with a consumer and to convey the chocolate mass towards the consumer;
a conveying pump being arranged in said conveying conduit;
a conduit including an exit and being designed and arranged to introduce a suspension including seed crystals into said conveying conduit;
a dose pump being arranged in said conduit; and
a tempering machine being connected to said conveying conduit and including at least one cooling stage and at least one mixing stage, said mixing stage having a beginning portion, said beginning portion being connected to said exit of said conduit in a way to introduce the suspension including seed crystals into the chocolate mass.

21. The apparatus of claim 20, wherein said tempering machine only includes one cooling stage and one mixing stage.

22. The apparatus of claim 20, wherein said conduit is designed and arranged to be part of a circuit being designed and arranged to pass the suspension through said circuit for a plurality of times to increase the amount of seed crystals.

23. The apparatus of claim 20, wherein said conduit includes an entrance being connected to a part of said conveying conduit between said tempering machine and said consumer.

24. The apparatus of claim 20, wherein said conduit includes an entrance and said cooling stage includes an end, said entrance of said conduit being connected to said end of said cooling stage.

25. The apparatus of claim 20, wherein said conduit includes an entrance being connected to said tank.

26. The apparatus of claim 20, further comprising an open mixing unit, a second dose pump and a static mixing unit all being located in said conduit.

27. The apparatus of claim 20, wherein said conduit is designed and arranged to continuously introduce the suspension including seed crystals into said conveying conduit.

28. The apparatus of claim 20, wherein the chocolate mass is liquid and has a processing temperature of approximately 31° C. to approximately 35° C.

29. The apparatus of claim 20, wherein said tempering machine has a conventional design, and wherein it is designed to be controlled to realize said at least one cooling stage and said at least one mixing stage.

30. An apparatus for continuously treating a chocolate mass to be processed, comprising:
a first conduit being designed and arranged to convey the chocolate mass;
a second conduit including an exit and being designed and arranged to introduce a suspension including seed crystals into said first conduit; and
a tempering machine being connected to said first conduit and including at least one cooling stage and at least one mixing stage, said mixing stage having a beginning portion, said beginning portion being connected to said exit of said second conduit in a way to introduce the suspension including seed crystals into the chocolate mass.
